(19) United States
(12) Patent Application Publication
(10) Pub. No.: US 2010/0198443 A1
(43) Pub. Date: Aug. 5, 2010

(54) PATH PLANNING DEVICE, PATH PLANNING METHOD, AND MOVING BODY

(75) Inventors: Hidenori Yabushita, Toyota-shi (JP); Kazuhiro Mima, Toyota-shi (JP); Yoshiaki Asahara, Obu-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/669,409

(22) PCT Filed: Jul. 4, 2008
(86) PCT No.: PCT/JP2008/062544

§ 371 Date: Jan. 15, 2010

(30) Foreign Application Priority Data
Jul. 17, 2007 (JP) 2007-186057

(51) Int. Cl. G05D 1/00; G01C 21/00

(52) U.S. Cl. 701/25; 701/201

(57) ABSTRACT

To provide a path planning device and a path planning method capable of, when installed in a moving body such as a robot, exhibiting a natural moving action, and a moving body having such a path planning device installed therein. A path planning device includes a path guide area setting unit that sets a first movement prohibited area for assisting moving path generation on one or both sides of the robot, and a path decision unit that determines a path to a target position such that the robot does not move inside the path guide area. The path guide area setting unit sets the path guide area such that its perimeter passes through the center of that robot.

### TECHNICAL FIELD

The present invention relates, for example, to a path planning device and a path planning method used in an autonomously movable moving body such as a robot to determine a moving path according to the surrounding situation, and a moving body having this path planning device installed therein.

### BACKGROUND ART

Robots of an autonomous type or the like are configured so as to recognize environments around themselves, draw up path plans, and move according to the plans. In the related art, Patent document 1 discloses, as a path planning device to be installed in such robots, a technique aimed at planning a moving path by using an environmental map to determine whether the movement is possible or not even in an area where there is a difference in level from the floor surface.

In the technique disclosed in Patent document 1, it includes a multiple plane extraction unit that extracts multiple planes including a floor surface by calculating a plane parameter from a parallax image or a range image, an obstacle recognition unit that recognizes an obstacle on multiple planes including the floor surface, an environmental map update unit that creates and updates an environmental map for each plane based on a recognition result of the obstacle recognition unit, and a path planning unit that performs path planning based on these environmental maps. Then, the path planning unit defines a given area as a candidate for a moving path, even if the area is recognized as an obstacle on the environmental map of the floor surface, if the area is not recognized as an obstacle on the environmental map of other planes. In general, in such path planning devices, the shortest path from the start to the goal is generated.

### [Patent Document 1]

### Japanese Unexamined Patent Application Publication No. 2005-92820

### DISCLOSURE OF INVENTION

### Technical Problem

However, the current position and the movement radius of the moving robot are not taken into consideration in the technique disclosed in Patent document 1, and therefore a path including a sharp curve for which the robot have difficulty to follow could be planned.

That is, in order to generate a moving path from the start to the goal, a shortest path searching technique is typically used. However, since the shortest path from the start to the goal is generated in the conventional shortest path search, a moving path including a sharp curve could be generated. In the case of wheel-type moving robots, it is very difficult to follow a path when the path includes such a sharp curve.

Further, in a case where a moving path that evades an obstacle is generated as shown in Patent document 1, the shortest path connecting the start and the goal is generated regardless of the robot position. Therefore, if there is a moving obstacle, a path that does not pass through the current robot position could be generated. In this case, the robot makes a sharp turn toward the path, and thereby exhibits an unnatural action. As described above, since conventional shortest path searching algorithms do not take the current position and the turning radius of a robot, they suffer from a problem that a path including a sharp curve could be generated.

The present invention has been made to solve such a problem, and an object thereof is to provide a path planning device and a path planning method capable of, when installed in a robot or the like, exhibiting a natural moving action, and a moving body having such a path planning device installed therein.

### Technical Solution

A path planning device in accordance with the present invention includes: a movement prohibited area setting unit that sets a first movement prohibited area for assisting moving path generation on one or both sides of a moving body; and a path decision unit that determines a moving path to a target position such that the moving body does not move inside the first movement prohibited area, wherein the movement prohibited area setting unit sets the first movement prohibited area so that the moving path passes through a center of the moving body.

In the present invention, for example, in a moving body such as a robot device or the like, the generation of a moving path that does not includes the center of the moving body is prevented by setting the first movement prohibited area, which guides the generation of a moving path such that the moving path of the moving body passes through the center of that moving body.

Further, the movement prohibited area setting unit can set the first movement prohibited area such that its perimeter comes into contact with both sides of the center of that moving body or an area occupied by that moving body. In this way, for example, in the case of a system in which a moving body is represented by point coordinates or a similar system, a first movement prohibited area(s) is established on both side of the center of the moving body, and in the case of a system in which a moving body is not represented by point coordinates, a first movement prohibited area is established so as to come into contact with an area occupied by that moving body, and by doing so, a moving path passing thorough the center of the moving body can be generated.

Further, it can further include an area adjustment unit that adjusts the size of the first movement prohibited area according to an action of the moving body. Therefore, the size of the movement prohibited area is adjusted so that the moving body turns gently or is allowed to turn sharply according to various actions such as when a human is on board, when a heavy object is carried, when liquid such as beverages is carried, or a similar situation.

Further, the area adjustment unit can be configured to adjust the size of the first movement prohibited area according to the moving speed of the moving body.

Further, the first movement prohibited area can be established as a circular or elliptic area. In this case, the area adjustment unit can make an adjustment such that the radius of the circle or ellipse forming the first movement prohibited area increases as the moving speed of the moving body increases. In this way, when the moving speed is high, sharp turns are prohibited, and thereby preventing the robot from skidding or toppling.

Further, it can further include an obstacle detection unit that detects an obstacle, so that the movement prohibited area setting unit can set a second movement prohibited area around an obstacle detected by the obstacle detection unit. In this way, the coordinates of a robot can be expressed as point coordinates, and processing load for various calculations can thereby be reduced.

Furthermore, the second movement prohibited area can be established as a circular or elliptic area containing the obstacle. In this case, the area adjustment unit can make an adjustment such that the radius of the circle or ellipse forming the second movement prohibited area increases as the moving speed of the moving body increases.

A path planning method in accordance with the present invention includes: a movement prohibited area setting step of setting the first movement prohibited area for assisting a moving path on one or both sides of a moving body; and a path decision step of determining a path to a target position such that the moving body does not move inside the first movement prohibited area, wherein, in the movement prohibited area setting step, the first movement prohibited area is set so that the moving path passes through a center of the moving body.

A moving body in accordance with the present invention includes: path planning means to generate a moving path; and moving means to move based on a moving path generated by the path planning unit, wherein the path planning means includes: a movement prohibited area setting unit that sets a first movement prohibited area so as to assist moving path generation and pass through a center of the moving body on one or both sides of the moving body; and a path decision unit that determines a moving path to a target position such that the moving body does not move inside the first movement prohibited area.

In the present invention, it is possible to make a moving body generate a moving path passing through the center of the moving body and exhibit a natural moving action.

### ADVANTAGEOUS EFFECTS

In accordance with the present invention, a path planning device and a path planning method capable of, when installed in a moving body such as a robot, exhibiting a natural moving action, and a moving body having such a path planning device installed therein can be provided.

### BRIEF DESCRIPTION OF DRAWINGS

FIG. 1 is a perspective view showing a bipedal walking type robot in accordance with an exemplary embodiment of the present invention;

FIG. 2 is a block diagram showing a robot in accordance with an exemplary embodiment of the present invention;

FIG. 3 is a block diagram showing a path planning device in accordance with an exemplary embodiment of the present invention;

FIG. 4 is a figure for explaining path guide areas set by a path guide area setting unit and a prohibited area set by a prohibited area setting unit in a path planning device in accordance with an exemplary embodiment of the present invention;

FIG. 5A shows path guide areas set by a path guide area setting unit in a path planning device in accordance with an exemplary embodiment of the present invention, and shows a case where the speed is low;

FIG. 5B shows path guide areas set by a path guide area setting unit in a path planning device in accordance with an exemplary embodiment of the present invention, and shows a case where the speed is high;

FIG. 5C shows path guide areas set by a path guide area setting unit in a path planning device in accordance with an exemplary embodiment of the present invention, and shows another example of a path guide area; and

FIG. 6 is a flowchart showing a path planning method in accordance with an exemplary embodiment of the present invention.

### EXPLANATION OF REFERENCE

1 ROBOT
2 HEAD UNIT
3A, 3B ARM UNIT
4A, 4B LEG UNIT
5 TRUNK UNIT
6 IMAGE PICKUP UNIT
12 IMAGE RECOGNITION MODULE
13 PATH PLANNING MODULE
14 ACTION DECISION MODULE
15 VOICE RECOGNITION MODULE
20 PATH PLANNING DEVICE
21 PATH GUIDE AREA SETTING UNIT
22 AREA ADJUSTMENT UNIT
23 OBSTACLE DETECTION UNIT
24 PROHIBITED AREA SETTING UNIT
25 PATH DECISION UNIT
31A, 31B PATH GUIDE AREA
40 OBSTACLE
41 PROHIBITED AREA
51 PATH
52 CURVED PATH
101 CONTROL UNIT
102 INPUT/OUTPUT UNIT
103 DRIVE UNIT
104 POWER SUPPLY UNIT
105 EXTERNAL STORAGE UNIT
121 CAMERA
122 BUILT-IN MICROPHONE
123 SPEAKER
125 SENSOR UNIT
131 MOTOR
132 DRIVER
141 BATTERY
142 BATTERY CONTROL UNIT

### BEST MODE FOR CARRYING OUT THE INVENTION

Specific exemplary embodiments to which the present invention is applied will be described hereinafter in detail with reference to the drawings. In these exemplary embodiments, the present invention is applied, for example, to a robot device which can move by a wheel(s) or the like and in which a path planning device capable of exhibiting a natural moving action is installed.

In a path planning device in accordance with this exemplary embodiment, a circular path guide area(s), within which the creation of a path is prohibited when a moving path is generated, is established on both side of a robot. Then, when a path to the target position (goal) is to be planed, the path is established in areas other than the path guide area, so that any path that involves a sharp turn is never generated even if there is an obstacle(s) or the like. Further, by setting a path guide area in such a manner that the size of the path guide area becomes larger as the speed increases, it makes the robot exhibit a more natural action. Firstly, a robot in which such a path planning device is installed is explained hereinafter.

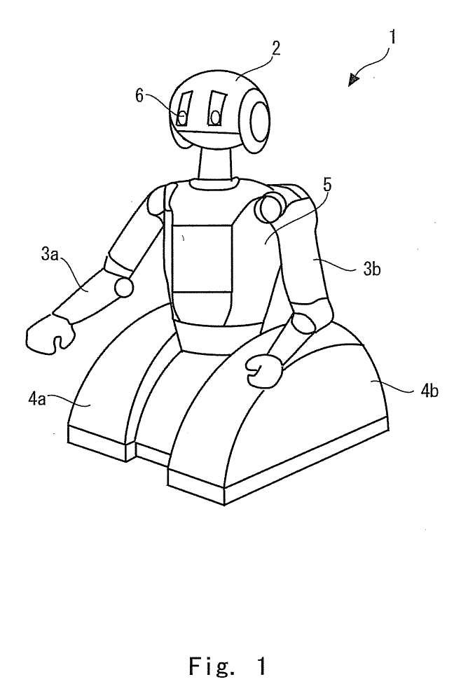

FIG. 1 is a perspective view showing a robot in accordance with an exemplary embodiment of the present invention. As shown in FIG. 1, a robot 1 includes a head unit 2, two left and right arm units 3a and 3b, and two left and right leg units 4a and 4b, each of which is coupled to a trunk unit 5 at a predetermined position. The robot 1 in accordance with this exemplary embodiment is configured such that it can move by wheels incorporated in the leg units 4a and 4b. Note that the robot may be a bipedal or quadrupedal walking type robot.

The head unit 2 includes an image pickup unit 6, and thus is capable of taking images of surroundings within a predetermined range. Further, the head unit 2 is provided with a microphone, a speaker, and the like (not shown), and thus is capable of recognizing an utterance from a user and responding to the utterance. The head unit 2 is connected to the trunk unit 5 so as to be rotatable in the left and right directions in a plane parallel to the floor surface. Therefore, images of the surrounding environment can be taken while the range in which an image is taken is changed by turning the head unit 2 according to the situation.

With regard to the arm units 3a and 3b and the leg units 4a and 4b, an arithmetic processing unit that is included in a control unit embedded in the trunk unit 5 controls the driving amount for joint portions contained in the arm units 3a and 3b respectively and for the wheels contained in the leg units 4a and 4b according to a predetermined control program, and determines the joint driving angle of each joint and the rotation angle of the wheels so that they take desired positions and postures.

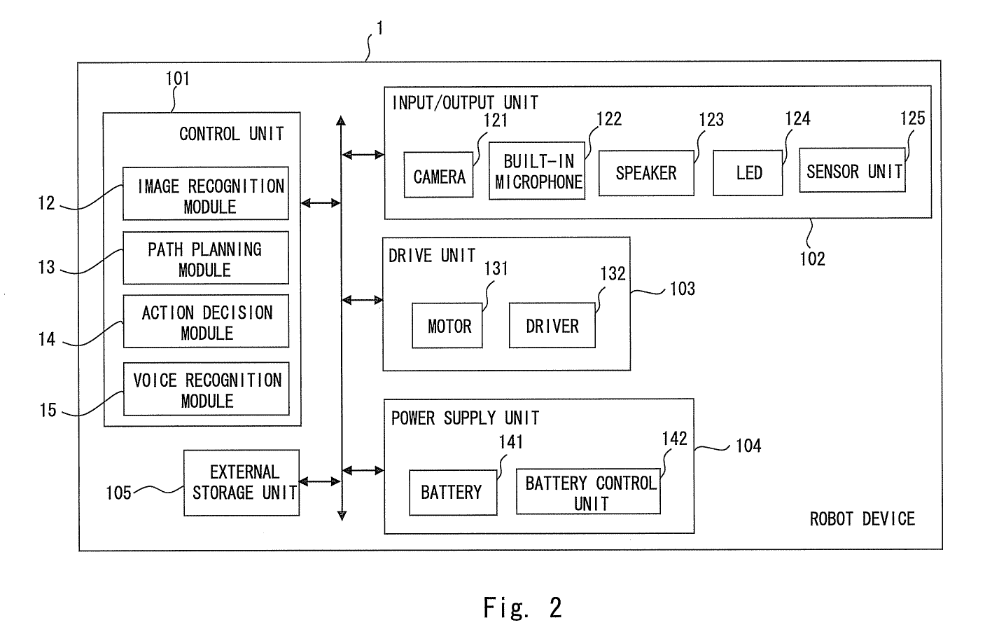

FIG. 2 is a block diagram showing the robot in accordance with this exemplary embodiment. The robot 1 includes a control unit 101, an input/output unit 102, a drive unit 103, a power supply unit 104, an external storage unit 105, and the like.

The input/output unit 102 includes a camera 121 composed of a charge coupled device (CCD) for picking up an image of the surroundings, one or more than one built-in microphone 122 for collecting ambient sounds, a speaker 123 for outputting a voice and having a conversation or the like with a user, an LED 124 for responding to the user and expressing feeling or the like, and a sensor unit 125 composed of a touch sensor or the like.

Further, the drive unit 103 includes a motor 131 and a driver 132 that drives the motor, and causes the leg units 4a and 4b and the arm units 3a and 3b to operate in accordance with an instruction or the like from the user. The power supply unit 104 includes a battery 141 and a battery control unit 142 that controls charge/discharge of the battery, and supplies electrical power to each unit.

The external storage unit 105 includes an HDD, an optical disk, a magneto-optical disk, and the like, which are detachably mounted, to store various programs, control parameters, and the like, and supplies, as the need arises, the programs and data to a memory (not shown) and the like provided within the control unit 101.

The control unit includes a central processing unit (CPU), a read only memory (ROM), a random access memory (RAM), and an interface for wireless communication, and controls various operations of the robot 1. Further, the control unit 101 includes an image recognition module 12 that analyzes an image obtained by the camera 121 in accordance with a control program stored, for example, in the ROM, a path planning module 13 that performs path planning based on an image recognition result, an action decision module 14 that selects an action to be performed based on various recognition results, a voice recognition module 15 that performs voice recognition, and the like.

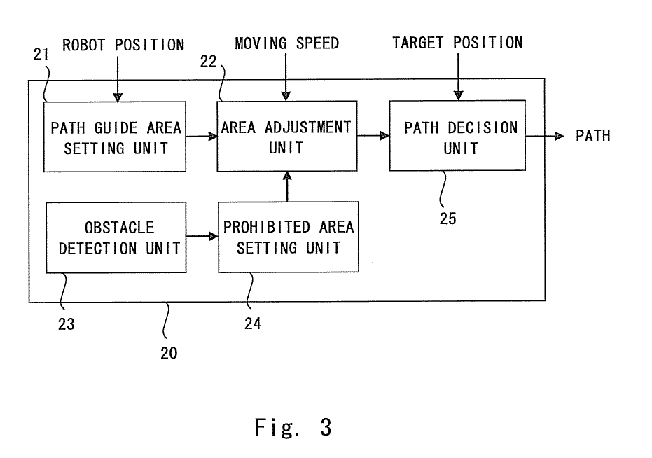

Note that the robot 1 in accordance with this exemplary embodiment generates a moving path that exhibits a natural action by setting a path guide area in the path planning module 13. Next, a path planning module in accordance with this exemplary embodiment is explained in detail. FIG. 3 is a block diagram showing a path planning device in accordance with this exemplary embodiment. Note that although the following explanation is made on the assumption that the path planning module is a path planning device, the processing of each block can be also realized by causing a CPU to execute a computer program. In this case, the computer program can be provided by recording it in a recording medium, or can be provided by transmitting it through a transmission medium such as the Internet.

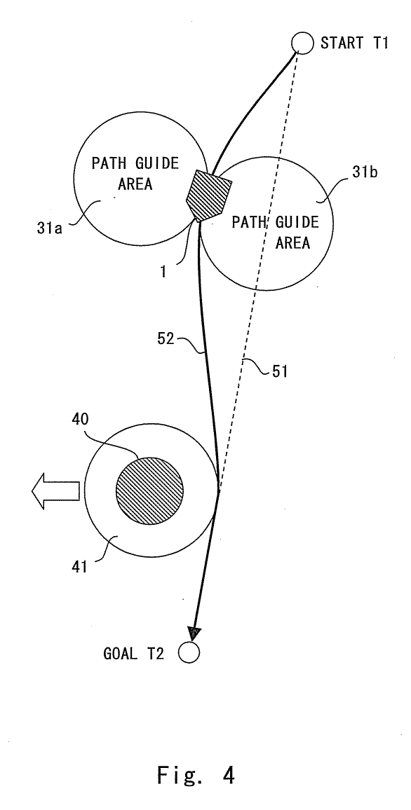

As shown in FIG. 3, a path planning device 20 includes a path guide area setting unit 21, an area adjustment unit 22, an obstacle detection unit 23, a prohibited area setting unit 24, and a path decision unit 25. FIG. 4 is a figure for explaining a path guide area set by the path guide area setting unit 21 and a prohibited area set by the prohibited area setting unit 24.

The path guide area setting unit 21 sets a path guide area as a first movement prohibited area(s) on one or both sides of the robot, i.e., moving body. This path guide area is an area to assist the moving path generation, and its perimeter passes through the center of the robot. Further, in this exemplary embodiment, path guide areas 31a and 31b having identical shapes are established on the left and right sides of the robot 1. These path guide areas 31a and 31b are imaginary movement prohibited areas that serves as a guide so that the moving path to be searched by the robot 1 passes through the current position of the robot 1 (robot center). Note that in this exemplary embodiment, the robot 1 sets path guide areas on both sides of the center of that robot. However, for example, in the case of a robot that rotates only in one direction, a path guide area may be established only in the direction in which the robot rotates. Further, the robot 1 in accordance with this exemplary embodiment expresses itself by point coordinates, and therefore path guide areas are established so as to sandwich those point coordinates (robot center). However, if a robot expresses itself by a certain line-segment or by an area corresponding to the robot, the path guide areas may be established so as to come into contact with the area occupied by that robot.

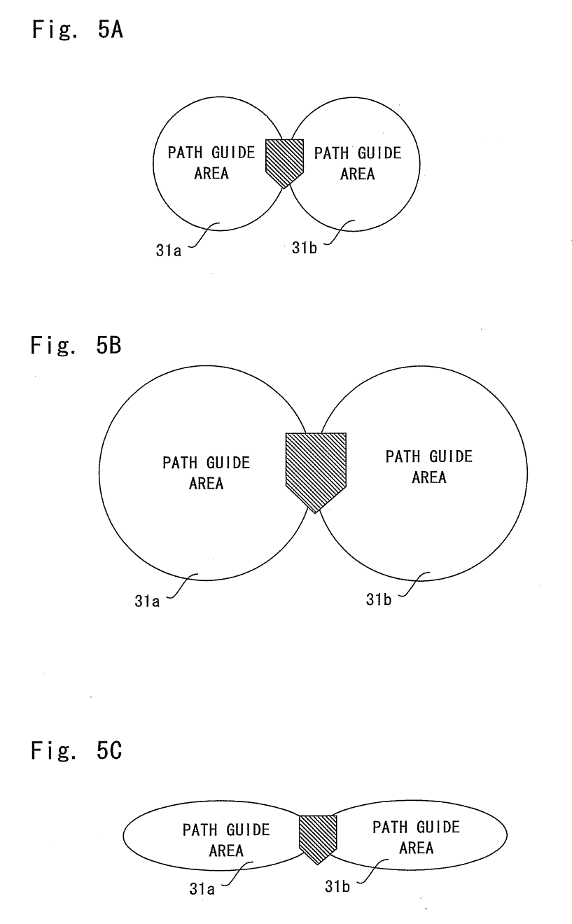

The area adjustment unit 22 adjusts the size of the path guide areas 31a and 31b according to an action of the robot. In this exemplary embodiment, the size of the path guide areas 31a and 31b is controlled such that the size of the path guide areas 31a and 31b becomes larger as the moving speed of the robot 1 increases. That is, when the moving speed of the robot 1 is high, it becomes more difficult to follow a path including a sharp curve. Therefore, the path guide areas 31a and 31b are adjusted according to the speed so that a more natural action can be exhibited. FIGS. 5A to 5C show path guide areas. When the moving speed of the robot 1 increases, the area adjustment unit 22 expands its setting areas from path guide areas shown in FIG. 5A to path guide areas shown in FIG. 5B.

Further, as shown in FIG. 5C, the path guide areas 31a and 31b are not limited to circular areas. The only requirement is that they should be areas that are surrounded by smooth curved lines and are composed of convexities alone. For example, they may be elliptic areas. If an ellipse is adopted, it can be configured such that the major axis is oriented in a direction perpendicular to the moving direction of the robot 1. By orienting the major axis in a direction perpendicular to the moving direction of the robot 1, it is possible to prevent the robot 1 from establishing a path in such a manner that it skirts around the path guide area from the behind.

Further, for example, in the case of a wheel-type moving robot, the moving distance is measured, in general, based on the number of revolutions of the wheel. Accordingly, if the robot skids, an accurate measurement of the moving distance becomes impossible. Therefore, it is important to move so as not to cause any slipping. Accordingly, it is necessary to establish path guide areas such that the robot 1 performs a rotational movement at the speed at which the robot 1 does not skid or topple.

Assume that the minimum force that, when exerted on the robot 1, causes the robot 1 to topple is “toppling force”, and that the minimum force that, when exerted on the robot 1, causes the robot 1 to skid is “friction force”. Further, assuming that the mass of the robot 1 is m, the path guide areas 31a and 31b are circles and their radius is r, and the moving speed of the robot 1 is v, the radius of the path guide areas 31a and 31b preferably satisfies the formula (friction force)·(toppling force)=mv2/r.

That is, if the friction force with which a skid occurs and the toppling force with which a toppling occurs become larger, a skid and a toppling become less likely to occur, and therefore the path guide areas 31a and 31b can be established with a smaller size. On the other hand, if a structure with which a skid or a toppling tends to occur more easily is adopted, the path guide areas 31a and 31b need to be established with a larger size.

The obstacle detection unit 23, which is, for example, a sensor unit 125 or the like, detects an obstacle(s) 40 by a sensor. Alternatively, image processing is performed by the image recognition module 12 on an image obtained by the camera 121 in order to recognize the size, position, height, and the like of the obstacle 40.

The prohibited area setting unit 24 sets a prohibited area 41 around an obstacle 40 detected by the obstacle detection unit 23 as a second movement prohibited area. Similarly to the path guide areas 31a and 31b, the prohibited area 41 may be a circular area containing the obstacle 40, but is not limited to circles provided that it is an area surrounded by smooth curved lines and composed of convexities alone.

The path decision unit 25 generates the minimum path from the start T1 to the goal T2. As for the path generation method, publicly-known algorithms such as Dijkstra method, A* search, and DP matching can be used. Note that in the related art, a path 51 is generated as the minimum path from the start T1 to the goal T2. In such a case, since the path 51 does not pass through the current position of the robot 1, the robot 1 turns sharply from the current position toward the path 51 in an attempt to follow the path 51. Such a sharp turn could become an unnatural action as an action of the robot 1.

By contrast, in this exemplary embodiment, the robot 1 cannot establish a path in the path guide areas 31a and 31b. Accordingly, a path generated by the robot 1 becomes a smoothly curbed path 52 that originates from the start T1, passes through the current position of the robot 1, and extends toward the goal T2, and thus enabling a natural movement.

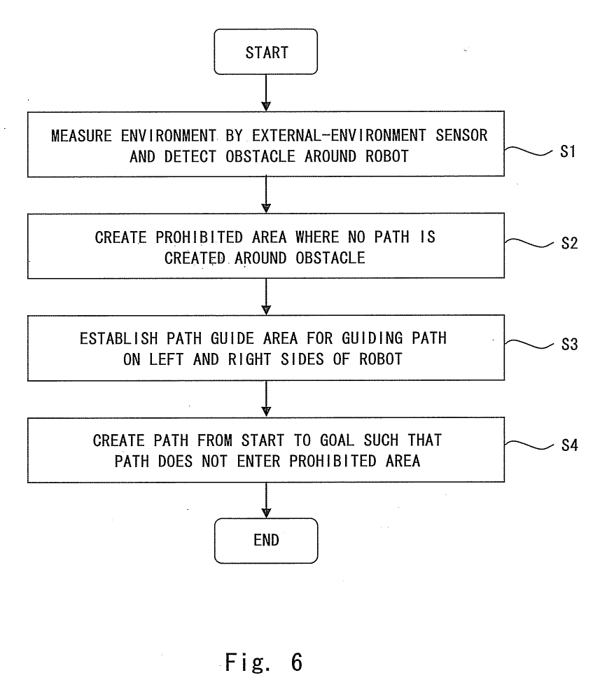

Next, a path planning method in accordance with this exemplary embodiment is explained. FIG. 6 is a flowchart showing a path planning method in accordance with an exemplary embodiment of the present invention. As shown in FIG. 6, an external-environment sensor measures an environment around the robot 1 and detects an obstacle(s) in the vicinity of the robot 1 (step S1). If an obstacle is detected by this obstacle detection, the prohibited area setting unit 24 establishes a prohibited area around the obstacle. The range of this prohibited area is determined as appropriate according to the moving speed of the robot 1.

Note that in this exemplary embodiment, a system in which the coordinates of the robot 1 is recognized as point coordinates is used. However, the robot 1 is, in reality, a moving body occupying a certain range (area). Therefore, in this exemplary embodiment, the robot 1 is expressed as point coordinates, instead, a range is provided for an obstacle as a prohibited area 41, and by doing so, the moving range of the robot 1 has a certain range. In this way, it is possible to prevent collisions or the like with the obstacle. Note that in the case of a system where the robot 1 is recognized with its actual size not being recognized by point coordinates, the provision of the prohibited area is unnecessary.

Next, the path guide area setting unit 21 establishes path guide areas 31a and 31b on both sides of the robot 1. At the same time, the area adjustment unit 22 adjusts the size of the path guide areas 31a and 31b according to the moving speed of the robot 1. Note that the area adjustment unit 22 may change the shape of the path guide areas 31a and 31b according not only to the moving speed of the robot 1, but also to the type of action, environment, situation, and the like of the robot 1. For example, if a human is on the robot 1, the radius of the path guide areas 31a and 31b may be increased so that the robot moves gently. Alternatively, if a heavy object is to be carried, the friction force increases. Therefore, the radius of the path guide areas 31a and 31b may be set to a smaller value. In this way, the radius of the path guide areas 31a and 31b can be also set according to the action.

Finally, a path from the start T to the goal T2 is generated while taking the path guide areas 31a and 31b and the prohibited area 41 into consideration. This series of path generation operations may be performed, for example, at intervals of once every several milliseconds or every several seconds, so that the optimal path can be established even in the case where the surround environment changes.

In this exemplary embodiment, a moving path is established in such a manner that if the robot is expressed by point coordinates, the moving path passes through those point coordinates (robot center), and that if the robot is not expressed by point coordinates, a path guide area(s) is established so as to come into contact with the area occupied by that robot and the moving path thereby does not pass through this path guide area(s). By doing so, a moving path passing through the current position of the robot is generated on all occasions. Further, the curvature of the path guide area is changed according to the moving speed of the robot, so that when the speed is high, the robot moves along a gentle curve, and when the moving speed is low, it turns with a smaller turning radius. Therefore, an action according to the speed can be exhibited.

Note that the present invention is not limited to above-described exemplary embodiments, and needless to say, various modifications can be made without departing from the spirit and the scope of the present invention.

### INDUSTRIAL APPLICABILITY

The present invention can be widely applied, for example, to path planning devices and path planning methods used in autonomously movable moving bodies such as robots to determine a moving path according to the surrounding situation, and moving bodies having such path planning devices installed therein.

1. A path planning device comprising:
a movement prohibited area setting unit that sets a first movement prohibited area for assisting moving path generation on one or both sides of a moving body; and
a path decision unit that determines a moving path that originates from a start position, passes through a center of the moving body in a current position, and reaches a target position such that the moving body does not move inside the first movement prohibited area.

2. The path planning device according to claim 1, wherein the movement prohibited area setting unit sets the first movement prohibited area such that its perimeter comes into contact with both sides of the center of that moving body or an area occupied by that moving body.

3. The path planning device according to claim 1, further comprising an area adjustment unit that adjusts a size of the first movement prohibited area according to an action of the moving body.

4. The path planning device according to claim 3, wherein the area adjustment unit adjusts a size of the first movement prohibited area according to a moving speed of the moving body.

5. The path planning device according to claim 1, wherein the first movement prohibited area is a circular or elliptic area.

6. The path planning device according to claim 5, wherein the area adjustment unit adjusts a size of the first movement prohibited area such that a radius of the circle or ellipse forming the first movement prohibited area increases as a moving speed of the moving body increases.

7. The path planning device according to claim 1, further comprising an obstacle detection unit that detects an obstacle,
wherein the movement prohibited area setting unit sets a second movement prohibited area around an obstacle detected by the obstacle detection unit.

8. The path planning device according to claim 7, wherein the second movement prohibited area is a circular or elliptic area containing the obstacle.

9. The path planning device according to claim 8, wherein the area adjustment unit adjusts a size of the second movement prohibited area such that a radius of the circle or ellipse forming the second movement prohibited area increases as a moving speed of the moving body increases.

10. A path planning method comprising:
a movement prohibited area setting step of setting the first movement prohibited area for assisting a moving path generation on one or both sides of a moving body in a current position; and
a path decision step of determining a path that originates from a start position, passes through a center of the moving body in a current position, and reaches a target position such that the moving body does not move inside the first movement prohibited area.

11. A moving body comprising:
a path planning unit to generate a moving path; and
a moving unit to move based on a moving path generated by the path planning unit,
wherein the path planning unit comprises:
a movement prohibited area setting unit that sets a first movement prohibited area so as to assist moving path generation on one or both sides of the moving body in a current position; and
a path decision unit that determines a moving path that originates from a start position, passes through a center of the moving body in a current position, and reaches a target position such that the moving body does not move inside the first movement prohibited area.

12. The moving body according to claim 11, wherein the moving unit is a wheel.
